(19) United States
(12) Patent Application Publication
(10) Pub. No.: US 2019/0340821 A1
(43) Pub. Date: Nov. 7, 2019

(54) MULTI-SURFACE OBJECT RE-MAPPING IN THREE-DIMENSIONAL USE MODES

(71) Applicant: Microsoft Technology Licensing, LLC, Redmond, WA (US)

(72) Inventors: Liang CHEN, Bellevue, WA (US); Michael Edward HARNISCH, Seattle, WA (US); Jose Alberto RODRIGUEZ, Seattle, WA (US); Steven Douglas DEMAR, Redmond, WA (US)

(21) Appl. No.: 15/989,041

(22) Filed: May 24, 2018

Related U.S. Application Data
(60) Provisional application No. 62/667,290, filed on May 4, 2018.

(51) Int. Cl. G06T 19/00; G06F 3/01; G06T 19/20

(52) U.S. Cl. CPC G06T 19/006; G06F 3/011; G06F 3/017; G02B 27/0172; G06T 2200/24; G06T 2219/2004; G06T 19/20

(57) ABSTRACT

The described technology provides for user-initiated re-mapping of virtual objects between different surfaces within a field-of-view of a user interacting with a processing device operating in a three-dimensional use mode. According to one implementation, a system disclosed herein includes a virtual content surface re-mapper stored in memory and executable by a processor to receive user input selecting one or more virtual objects presented on a virtual interface of an application; identify one or more surfaces within a field-of-view of the user that are external to the application; and present a surface selection prompt requesting user selection of one of the identified surfaces. Responsive to receipt of a surface selection received in response to the surface selection prompt, the virtual content surface re-mapper projects the one or more selected virtual objects onto a plane corresponding to a surface designated by the surface selection instruction.

### CROSS-REFERENCE TO RELATED APPLICATIONS

The present application claims benefit of priority to U.S. Provisional Application No. 62/667,290, entitled “Projection of Collection Content onto Virtual and/or Physical Surfaces in MR/VR Modes” and filed on May 4, 2018, which is specifically incorporated by reference for all that it discloses or teaches.

### BACKGROUND

Augmented reality (AR) technology allows virtual imagery to be mixed with a real world physical environment. Typically, AR headsets include see-through near eye displays (NED) that are worn by users to view the mixed imagery of virtual and real-world objects. In contrast, virtual reality (VR) headsets are designed to immerse the user in a virtual world. A variety of VR and AR applications project virtual interfaces, including three-dimensional objects that the user is able to interact with. For example, a user may use a controller or touch gestures to select, move, or otherwise manipulate three-dimensional virtual objects on a virtual interface that appears to be floating in air. However, it can feel unnatural to interact with these floating interfaces. Additionally, smaller fonts are difficult to decipher with some VR/AR headsets. This limitation provides an incentive to reduce the amount of text and increase the size of text displayed on VR interfaces, creating challenges in preserving application functionality in AR/VR modes without overcrowding interfaces.

### SUMMARY

Implementations disclosed herein provide a system comprising a virtual content surface re-mapper stored in memory and executable to receive user input selecting one or more virtual objects presented on a virtual interface of an application; identify one or more surfaces external to the application and within a field-of-view of a user; and present a surface selection prompt to a user. Responsive to receipt of a surface selection instruction received in response to the surface selection prompt, the virtual content surface re-mapper projects the one or more selected virtual objects onto a plane corresponding to a surface designated by the surface selection instruction.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example system that facilitates user-initiated re-mapping of virtual objects between different virtual and/or or real-world surfaces viewable through projection optics of a processing device operating in a three-dimensional use mode.

FIG. 2A illustrates inputs provided to an example system with a virtual content surface re-mapper during a virtual object selection step that initiates selective re-projection of content between different surfaces viewable through projection optics of a device operating in three-dimensional use mode.

FIG. 2B illustrates the example system of FIG. 2A during a subsequent portion of the virtual object selection step.

FIG. 2C illustrates the example system of FIGS. 2A and 2B in a state following the virtual object selection step.

FIG. 2D illustrates the example system of FIG. 2A-2C during a surface selection step following the virtual object selection step.

FIG. 2E illustrates the example system of FIG. 2A-2D during a re-projection step following the surface selection step.

FIG. 2F illustrates the example system of FIG. 2A-2E during another surface selection step.

FIG. 2G illustrates the example system of FIG. 2A-2F during another re-projection step following the surface selection step.

FIG. 3A illustrates an example arrangement of virtual objects projected onto a surface by a virtual content surface re-mapper of a device operating in a three-dimensional use mode.

FIG. 3B illustrates a user positioned relative to the example arrangement of virtual objects shown in FIG. 3A.

FIG. 4A illustrates another example arrangement of virtual objects projected onto a surface by a virtual content surface re-mapper of a device operating in a three-dimensional use mode.

FIG. 4B illustrates a user positioned relative to the example arrangement of virtual objects shown in FIG. 4A.

FIG. 5 illustrates example operations for re-mapping virtual objects between different virtual and/or or real-world surfaces.

FIG. 6 illustrates an example schematic of a processing device suitable for implementing aspects of the disclosed technology.

### DETAILED DESCRIPTIONS

The herein disclosed technology allows a user interacting with content projected in a three-dimensional virtual reality (VR) or augmented reality (AR) device mode to selectively move virtual objects between different surfaces (such as virtual surfaces or real-world surfaces). With this functionality, a user can self-create multiple different virtual workspaces in a room and place content on each different workspace to view in isolation of other projected virtual content. This control over the selection of surfaces to receive projected content facilitates a more natural emotional connection to virtual content by allowing virtual objects to behave in a realistic way with other virtual objects and/or real-world surroundings. For example, a user may select a collection of documents (e.g., photos) from a virtual interface and spread those documents out across a real-world table or virtual surface external to the application to view them as if they were indeed actual physical documents.

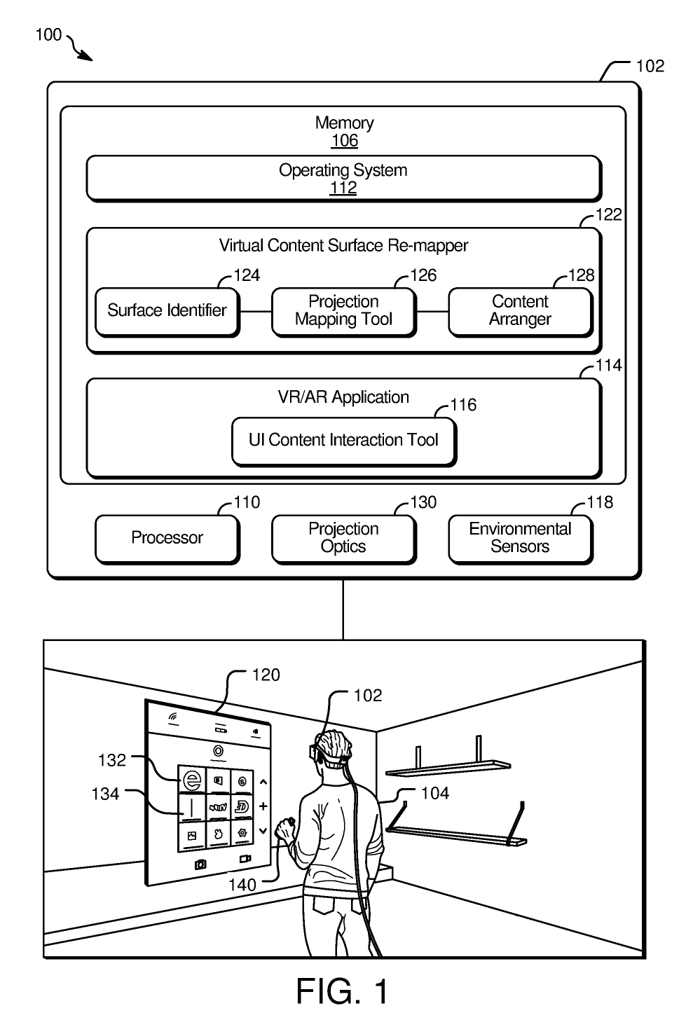

FIG. 1 illustrates an example system 100 that facilitates user-initiated re-mapping of virtual objects between different virtual and/or or real-world surfaces that appear within a field of a view of a user 104 interacting with virtual content projected by a processing device 102 operating in a three-dimensional use mode (e.g., an AR or VR mode). Although the processing device 102 may assume other forms in various implementations, the processing device 102 is, in FIG. 1, shown to be a head-mounted device (HMD) that uses projection optics 130 to project virtual content into the field-of-view of the user 104.

The processing device 102 may, in some implementations, be an AR device, VR device, or a device that is configured for selective use in multiple different AR and/or VR modes. If the processing device 102 is operating in an AR mode, the user 104 is able to see through the processing device 102 while virtual objects are presented in the foreground against the backdrop of the real-world surroundings. If the processing device 102 is operating in a VR mode, the user 104 is immersed in virtual surroundings and unable to see through real-world surroundings through the projection optics 130.

The processing device 102 includes at least a processor 110 as well as memory 106 storing an operating system 112 and at least one AR/VR application 114 executable by the processor 110. As used herein, an AR/VR application refers to an application that provides the user 104 with an AR or VR mode experience. During execution of the AR/VR application 114, the projection optics 130 are used to project virtual content into the field-of-view of the user 104.

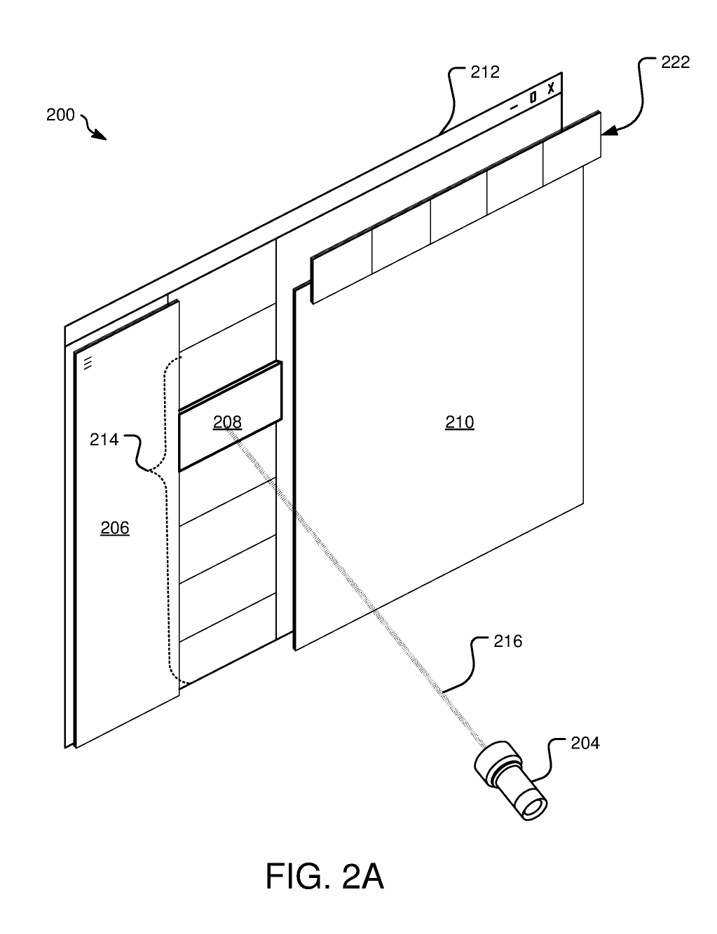

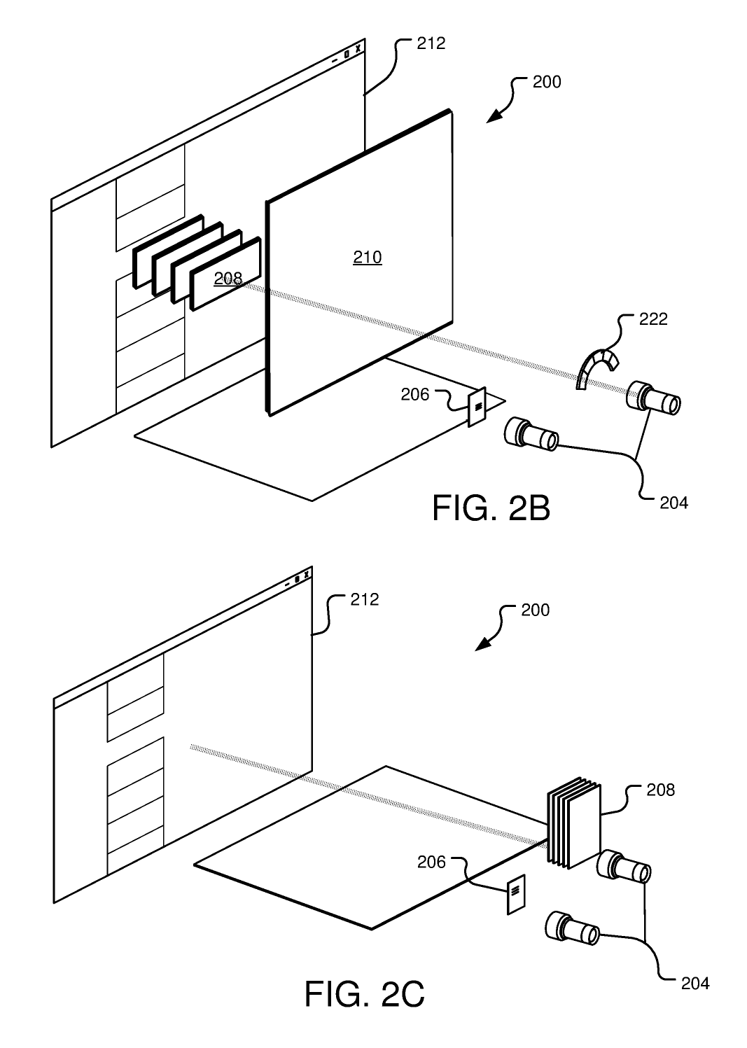

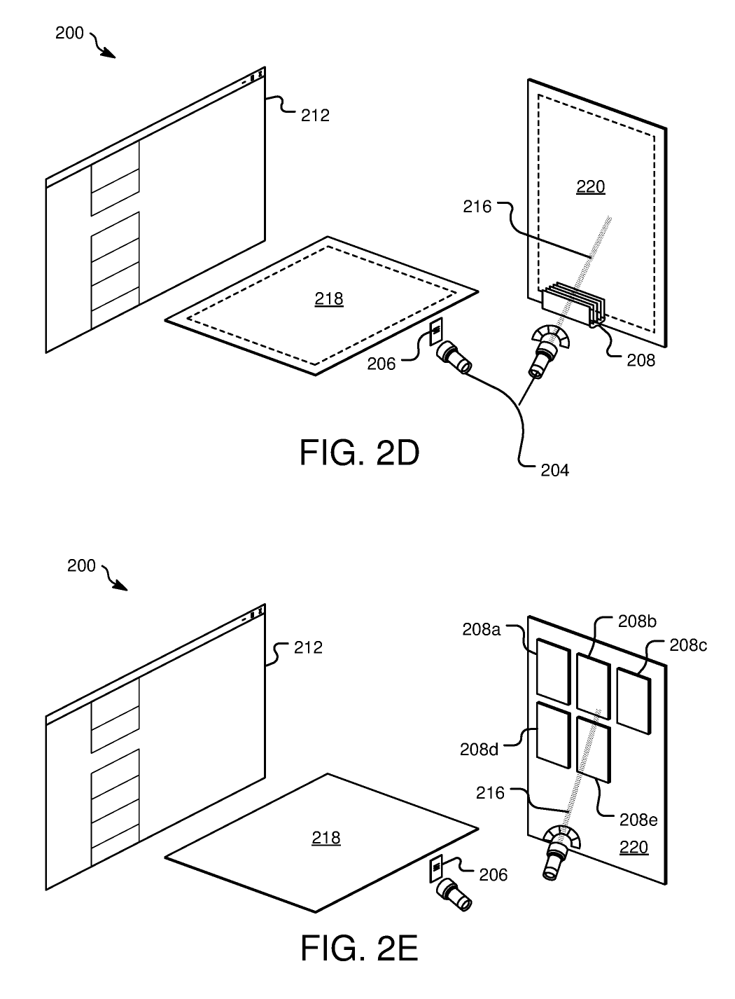

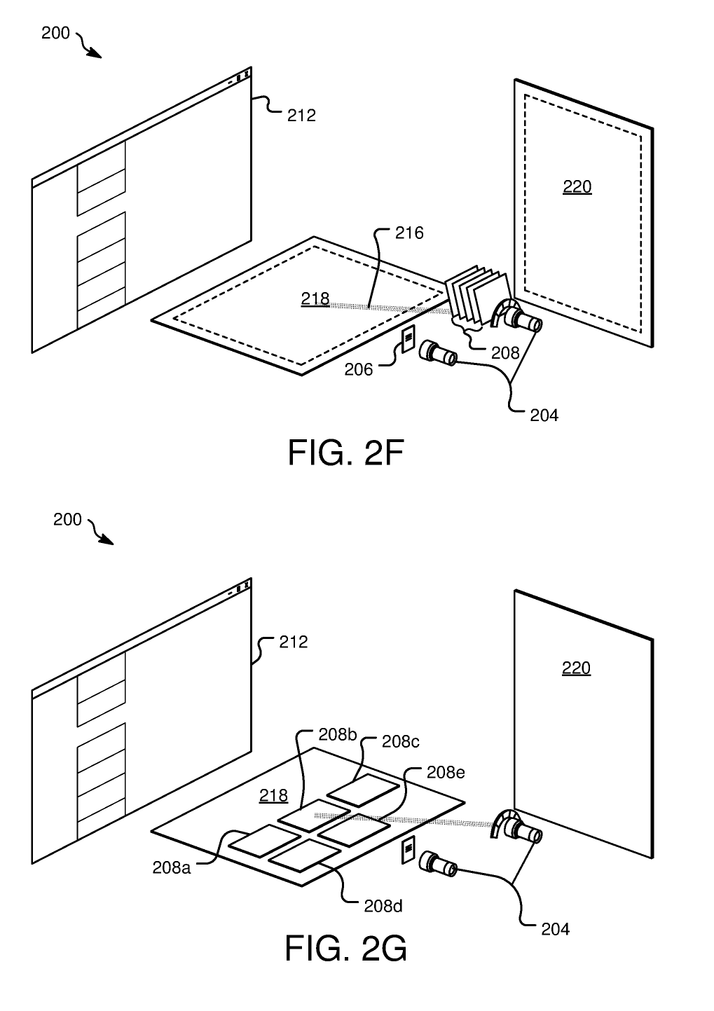

User inputs are provided to the AR/VR application 114 via a user interface (UI) content interaction tool 116. In one implementation, the UI content interaction tool 116 receives user input through a physical controller 140 (e.g., a handheld or wearable controller) that is wired or wirelessly coupled to the processing device 102. In one example shown with respect to FIGS. 2A-2G below, the operating system 112 projects a virtual “beam” from a hand-held controller, and the user moves the controller to select one or more selectable virtual objects (e.g., virtual objects 132, 134) with the beam, such as by clicking a button on the controller while the virtual beam is highlighting a virtual object of interest, such as a file, photo, message, icon, etc. In another implementation, the UI content interaction tool 116 receives user inputs through various environmental sensors 118 of the processing device 102. For example, the UI content interaction tool 116 may detect user inputs from one or more cameras, depth sensors, microphones, or heat sensors mounted on or otherwise in communication with the processing device 102. In one such implementation, the UI content interaction tool 116 receives imagery from a camera and uses gesture-recognition software to decipher hand gestures signifying user interactions with various virtual objects, such as gestures signifying touching, tapping, pinching, and dragging to select one or more of the virtual objects 132, 134.

By providing inputs to the UI content interaction tool 116 as described above, the user 104 selects one or more of the virtual objects 132, 134 presented by the AR/VR application 114. In the example of FIG. 1, the selectable virtual objects 132, 134 are shown initially projected on a virtual interface 120, which appears floating in space in front of the user 104. In other implementations, the selectable virtual objects 132, 134 may take on different forms and be presented differently. For example, some selectable virtual objects 132, 134 may initially appear projected onto a real-world surface, such as a table or wall.

Responsive to receipt of user input selecting one or more of the virtual objects 132, 134, the AR/VR application 114 provides information about each one of the selected virtual objects to a virtual content surface re-mapper 122. The virtual content surface re-mapper 122 operates external to the AR/VR application 114 and may, in some implementations, be integrated within the operating system 112. In general, the virtual content surface re-mapper 122 performs coordinate remapping of user-selected virtual objects 132, 134 and communicates with the AR/VR application 114 and/or a graphics engine (not shown) to move (re-project) the user-selected virtual objects 132, 134 in three-dimensional coordinate space to place the objects on a user-selected virtual or physical surface that is external to the AR/VR application 114. For example, the user 104 may wish to move selected virtual content items to a different physical or virtual surface where the selected objects can be more easily previewed, reached, or displayed in greater detail (e.g., shown larger, shown to include content initially hidden, re-arranged in a desired way).

The virtual content surface re-mapper 122 is shown to include a surface identifier 124 and a content arranger 128 and projection mapping tool 126. Responsive to the user 104 selection of one or more virtual objects 132, 134 via inputs provided to the UI content interaction tool 116, the surface identifier 124 identifies available surfaces onto which the selected virtual objects 132, 134 may be re-projected. In various implementations, these identified surfaces may be virtual or real-world surfaces.

In one implementation, the virtual content surface re-mapper 122 receives a selection of virtual objects 132, 134 projected by the AR/VR application 114 and re-maps those objects 132, 134 for projection onto another virtual surface generated (e.g., spawned by) a different application. For example, the user 104 may select one or more virtual objects 132, 134 from the virtual interface 120 of the AR/VR application 114 and move those selected objects 132, 134 to another virtual surface that is generated by another application, such as the operating system 112. For example, the surface identifier 124 may determine that operating system 112 has generated a virtual wall at some offset relative to the virtual interface 120 and recognize this virtual wall as a potential projection surface.

In another implementation where the processing device 102 operates in an AR mode, the surface identifier 124 identifies one or more real-world surfaces within a field-of-view of the projection optics 130 as being potential projection surfaces. For example, the surface identifier 124 may identify real-world surfaces such as walls and tables by analyzing collected camera data or depth sensor data. In this implementation, the user 104 is able to select virtual objects 132, 134 from the virtual interface 120 of the AR/VR application 114 and initiate a re-projection of the selected virtual objects 132, 134 onto a select physical surface in the real world (e.g., a wall, a table).

In some implementations, the surface identifier 124 presents a prompt that enables the user 104 to view the identified potential projection surface(s) recognized by the surface identifier 124 and/or selects a designated surface from the collection of identified potential projection surface(s). For example, the surface identifier 124 may project virtual markings onto the surfaces, such as to overlap virtual surfaces or appear on real-world surfaces. In one implementation, the surface identifier 124 project highlights to indicate each identified potential projection surface to the user 104.

Responsive to the user's 104 designation of a select one of the identified potential projection surfaces, the content arranger 128 and projection mapping tool 126 determine three-dimensional coordinates of the user-designated surface (hereinafter the designated surface) as well as new coordinates for each of the selected virtual objects 132, 134 sufficient to cause the virtual objects to appear on the user-designated surface. The content arranger 128 and projection mapping tool 126 determine an arrangement of the virtual objects 132, 134 and/or associated content and also determines coordinates at which to project the arranged content of the virtual objects 132, 134 onto the user-designated surface.

In various implementations, the arrangement and coordinate mapping may be based on a variety of different factors, including attributes of the designated surfaces, attributes of the user 104, and/or attributes of the individual virtual objects 132, 134 subject to the re-projection. A few exemplary arrangements and mappings of selected virtual objects 132, 134 are discussed in greater detail below with respect to FIGS. 2D, 3, and 4.

After determining reprojection coordinates for each of the selected virtual objects, the content arranger 128 and projection mapping tool 126 may provide the AR/VR application 114 with a set of instructions that causes the graphics engine to move (re-project) the virtual content items to appear on (e.g. spread out across) the user-designated surface.

FIGS. 2A-2F illustrate example operations for selecting virtual objects from a virtual interface and selectively re-projecting those objects onto other surfaces in a three-dimensional environment.

FIG. 2A illustrates example inputs to a system 200 with a virtual content surface re-mapper (such as the virtual content surface re-mapper 122 of FIG. 1) during a virtual object selection step that initiates selective re-projection of content between different surfaces viewable through projection optics of a device operating in three-dimensional mode of use (e.g., AR or VR). In the illustrated example, a user (not shown) operates a controller 204 to select one or more virtual objects (e.g., virtual objects 206, 208, 210, 222) from a virtual interface 212. The virtual interface 212 is, in one implementation, projected so as to appear floating in air within the user's field-of-view.

Although the virtual objects 206, 208, 210, 214 are represented as basic shapes, it may be understood that these objects may represent a variety of different types of user interface elements.

In one example implementation, the virtual interface 212 represents a window of an email application. Here, the virtual object 206 includes a navigation pane that allows a user to navigate between different mail boxes. A column 214 of rectangular virtual objects 206, 208 includes condensed information (e.g., subject line, sender, timestamp information) for each of several emails in a mailbox currently-selected from the navigation pane. Some of the emails in the column 214 may represent collections of emails (threads). For example, the virtual object 208 may represent an email thread including several messages back and forth to a same recipient. To save space, the email thread is represented in a condensed format where the virtual object 208 includes information about the most recent email in the thread and/or an indicator that the virtual object 208 is a collection of content that can be selected to view individual items in the collection. In this example, the virtual object 210 represents a current email message, such as the message content of the virtual object that is currently selected in the column 214, and the virtual object 222 represents a control panel that allows the user to provide commands to the application (e.g., compose a message, add an attachment, send a message, copy, paste).

In FIG. 2A, a user provides input to the virtual content surface re-mapper by moving the controller 204 to highlight a virtual object of interest (e.g., the virtual object 208). Here, projection optics of the system allow the user to see a virtual projection beam 216 extending from the controller 204. The user tilts the controller 204 to highlight the virtual object 208 with the virtual projection beam 216 and provides additional input to select the beam, such as by pressing a button with a controller. In another implementation, the user selects the virtual object 208 using hand gestures instead of a controller.

As used herein, the term “selected virtual object” refers to a virtual object that is selected as well as its corresponding sub-objects, if any exist. If, for example, the selected virtual object 208 represents a collection of content, the selected virtual object 208 includes the individual objects of the collection. Thus, if the user selects an email thread stack (as in the above example), the selected virtual objects include the object representing the thread as well as the individual emails of the email thread.

FIG. 2B illustrates the system 200 during a subsequent portion of the virtual object selection step described with respect to FIG. 2A. After the user selects the virtual object 208, the virtual content surface re-mapper presents an animation to indicate that the system 200 is preparing to receive a surface selection instruction from a user.

During the illustrated animation, some of the virtual items representing navigation controls and command controls are moved away from the virtual interface 212 and toward left and right-hand controls of the controller 204. For example, the navigation pane represented by the virtual object 206 is condensed and appears to hover near the left-hand controls of the controller 204. The command panel represented by the virtual object 222 is condensed and appears to hover near the right-hand controls of the controller 204. As the user moves the controller 204 about a room, the virtual objects 206 and 222 may stay close to the controller 204 as shown, allowing the user to access the controls without looking at the virtual interface 212. For example, different controls on the right-hand side of the controller 204 may correspond to the different commands in the command panel (represented by the virtual object 222) and controls on the left-hand side of the controller 204 may allow the user to access navigation options associated with the virtual object 206.

The selected virtual object 208 (e.g., an email thread) and the virtual object 210 (e.g., message content of one email from the email thread) appear to move in three-dimensional space toward the controller 204.

FIG. 2C illustrates the example system 200 in a state following the virtual object selection step described with respect to FIGS. 2A-2B. After the user selects the virtual object 208, virtual content begins to move as described above with respect to FIG. 2B. At the conclusion of this movement, the selected virtual object 208 (e.g., a collection of content) is projected near to the controller 204, as shown. This signifies that the user now has control to provide a surface selection instruction.

FIG. 2D illustrates the example system 200 during a surface selection step following the virtual object selection step described with respect to FIGS. 2A-2C. Here, the system 200 identifies potential projection surfaces (e.g., surfaces 218, 220) within a user's field-of-view. In one implementation, one or more of the identified potential projection surfaces (e.g., the surfaces 218, 220) are virtual surfaces external to the application that generates the virtual interface 212 and its associated virtual objects described with respect to FIGS. 2A-2C. For example, one or more of the potential projection surfaces (e.g., the surfaces 218, 220) may be a surface generated by an operating system of the device. In another implementation, one or more of the potential projection surfaces (e.g., the surfaces 218, 220) are real-world surfaces visible through projection optics of the system 200. For example, the surface 218 may be the user's coffee table or kitchen table and the surface 220 may be the user's wall, refrigerator, etc.

The system 200 projects virtual markings (e.g., highlights indicated by dotted lines) around each of the identified potential projection surfaces. By tilting the controller 204, the user causes the projection beam to point to the surface 220. The user provides additional input (e.g., selects a button while the virtual projection beam 216 is positioned as shown) to transmit a surface selection instruction selecting the surface 220.

Responsive to receipt of the surface selection instruction illustrated in FIG. 2D, the virtual content surface re-mapper determines an arrangement for the selected virtual objects. In various implementations, this determination is based on a variety of inputs including, without limitation, inputs from the application that created the virtual objects (e.g., the email application) and/or other applications. For example, the application that created the virtual objects may provide the virtual content surface re-mapper with information such as the total number of selected virtual content items, shape data or other information for determining a mapping of each of the selected virtual objects in three-dimensional space, and/or the type of data (e.g., whether the selected virtual objects are text files, photos, audio).

In one implementation, the virtual content surface re-mapper content determines a presentation format for the re-projection of each of the selected virtual objects based on a data type identifier received from the application that owns (generates) the selected virtual objects (e.g., the virtual object 208). For example, the data type identifier may indicate a type of content represented by the virtual object and/or further indicate whether each of the virtual objects include text data, audio data, imagery, etc. Based on the data type identifier, the virtual content surface re-mapper determines a general shape and layout for each individual one of the selected virtual objects on the designated surface 220. For example, a text file data type identifier may be pre-associated with a first defined object shape for the re-projection, while an image file may be pre-associated with a second defined object shape for the re-projection.

In another implementation, the application that owns the selected virtual objects provides the virtual content surface re-mapper with shape data for each of the selected virtual objects usable for determining coordinates of the re-projection. If, for example, the selected virtual objects include photo data, the application may provide the virtual content surface re-mapper with information such as an aspect ratio of each photograph to be preserved in the re-projection.

In another implementation, the virtual surface content re-mapper receives a data type identifier indicating that a selected virtual object includes a collection of content (e.g., that the selected virtual object 208 is a directory icon representing multiple files, a photo album including multiple photos, a playlist of audio or video data, an email thread, news stack, etc.) and also indicating the type of content in the collection. Responsive to receipt of a data type identifier, the virtual content surface re-mapper selects an expanded presentation format for the re-projection in which the items of the collection are spread out across the designated surface so as to permit a user to individually view, select, manipulate, and otherwise interact with the individual items of the collection of content. If, for example, the selected virtual object 208 is a condensed email thread, the virtual content surface re-mapper may receive a data type identifier “email thread” and a number of emails (e.g., five emails) in the thread. The virtual content surface re-mapper determines that the identifier “email stack” is associated with a rectangular content box for each email and selects a presentation format with five rectangles to be spread out across the designated surface according to an arrangement based on user attributes and/or surface.

In addition to selecting presentation format for each individual one of the selected virtual objects, the virtual content surface re-mapper also selects coordinates on the designated surface 220 for presenting each of the selected virtual objects according to the determined presentation format. This positioning may be based on a variety of different factors including attributes of the designated surfaces, attributes of the user, and/or attributes of the individual virtual objects subject to the re-projection.

In one implementation, the virtual content surface re-mapper uses inputs collected by environmental sensors of the system 200 to determine coordinates for the selected virtual objects on the designated surface 220. For example, the virtual surface content re-mapper may utilize environmental sensor data to determine information, such as physical attributes of the user and/or physical attributes of the selected surface (if the selected surface is a physical surface) including without limitation size, user height, user and surface location (e.g., separation of the surface and the user relative to one another), surface orientation, etc.

If the designated surface 220 is a virtual surface, the virtual content surface re-mapper may receive attributes of the designated surface 220 from the application that owns (provides the graphics engine with a rendering instruction to create) the designated surface 220 including without limitation attributes such as size, location, orientation, etc.

In still other implementations, the virtual content surface re-mapper obtains user profile information from the operating system and, from the profile information, determines user preferences relevant to content layout and arrangement. For example, a user profile may indicate a preferred placement of objects within reach of a specified dominant hand of the user.

In one implementation, the virtual content surface re-mapper selects positions for the virtual objects based on the orientation (e.g., vertical or horizonal) of the designated surface 220 and/or a size or aspect ratio of the designated surface 220. In the same or another implementation, the virtual content surface re-mapper selects positions for the virtual objects based on the position of the user relative to the designated surface 220 (e.g., the distance between the user and the designated surface 220) and/or one or more dimensions (e.g., arm length, height) of the user. For example, the virtual objects may be presented in an area of the designated surface 220 that is within arm's reach of the user, allowing the user to easily interact with the objects. Notably, the determination of “arm's reach” also depends on the distance between the user and the designated surface 220. If the designated surface 220 is vertical (e.g., a wall), the identification of the area that is within arm's reach may also depend on a detected height of the user.

In another implementation, the virtual content surface re-mapper determines a hand preference of the user and selects positions for the virtual objects based on the determined hand preference (e.g., by selecting positions that are readily reachable by the preferred hand (e.g., right or left)). Determining a hand preference may include identifying a hand that is dominant, active, or for any reason more available than the other hand. For example, the virtual content surface re-mapper may access user profile preferences to identify a pre-specified dominant hand preference or analyze environmental sensor data to determine which hand of the user was most recently used to interact with virtual content. In still another implementation, the virtual content surface re-mapper analyzes environmental sensor data to identify hand availability and selects positions for the virtual objects based on the identified hand availability. If, for example, the sensor data indicates that the user is holding a cup of coffee in one hand, the virtual content surface re-mapper selects positions for the virtual objects that are reachable by the other hand that is free.

In still another implementation, the virtual surface content re-mapper selects positions for the virtual objects based on the real-world analogy of the virtual objects. If, for example, the selected virtual objects are photographs, the virtual surface content re-mapper may select a realistic size for presenting each photograph (e.g., 3×4 inches or 5×7 inches). Alternatively, the virtual surface content re-mapper may select a size for presenting each photograph that appears realistic relative to the size of the designated surface and/or the user. For example, the re-projected virtual content items may appear to have a size relative to the selected surface that is similar to a ratio of the corresponding real-world object and surface size.

In yet another implementation, the virtual surface content re-mapper determines multiple different presentation options, each option including a different arrangement, and permits the user to select between the different presentation options. For example, the virtual content surface re-mapper may provide the application that owns the selected virtual objects with a set of instructions that causes the graphics engine to project the selected virtual objects according to a first arrangement and allow the user to selectively scroll through each different presentation option and select a preferred one of the presentation options.

FIG. 2E illustrates the example system 200 during a re-projection step following the surface selection step of FIG. 2D. In the illustrated example, the user has selected a virtual object 208 (as shown in FIG. 2B-2C), which has a data type identifier representing a collection of content. The virtual content surface re-mapper has received the user selection of the virtual object 208 and the associated data type identifier and, based on the data type identifier, selected positions for individual virtual objects 208a, 208b, 208c, 208d, and 208e included within the collection represented by the virtual object 208. In different implementations, the determined positions may be based on a variety of different factors such as surface attributes, user attributes, and user profile information (e.g., as described above with respect to FIG. 1).

Responsive to receipt of the surface selection instruction, the system 200 projects the selected virtual objects onto the designated surface 220 according to the determined arrangement and positions.

FIG. 2F illustrates the example system 200 during another surface selection step. Here, the user has provided input via the controller 204 to select each of the virtual objects 208a-208e from the surface 220 (e.g., where 208a-208e are subobjects in the collection represented by the virtual object 208 in FIG. 2A, 2B, 2C, and 2E). The system 200 has condensed the virtual objects 208a-208e into a stack shown near to the controller 204. Again, the system presents highlights around the identified projection surfaces (e.g., the surfaces 218 and 220). The user tilts the controller 204 to highlight the surface 218 with the virtual projection beam 216 and provides further input to transmit a surface selection instruction selecting the surface 218.

FIG. 2G illustrates the example system 200 during another re-projection step following the surface selection step of FIG. 2F. Here, the system 200 projects the selected virtual objects 208a, 208b, 208c, 208d, and 208e according to the determined arrangement onto the surface 218 that the user has selected via the surface selection instruction.

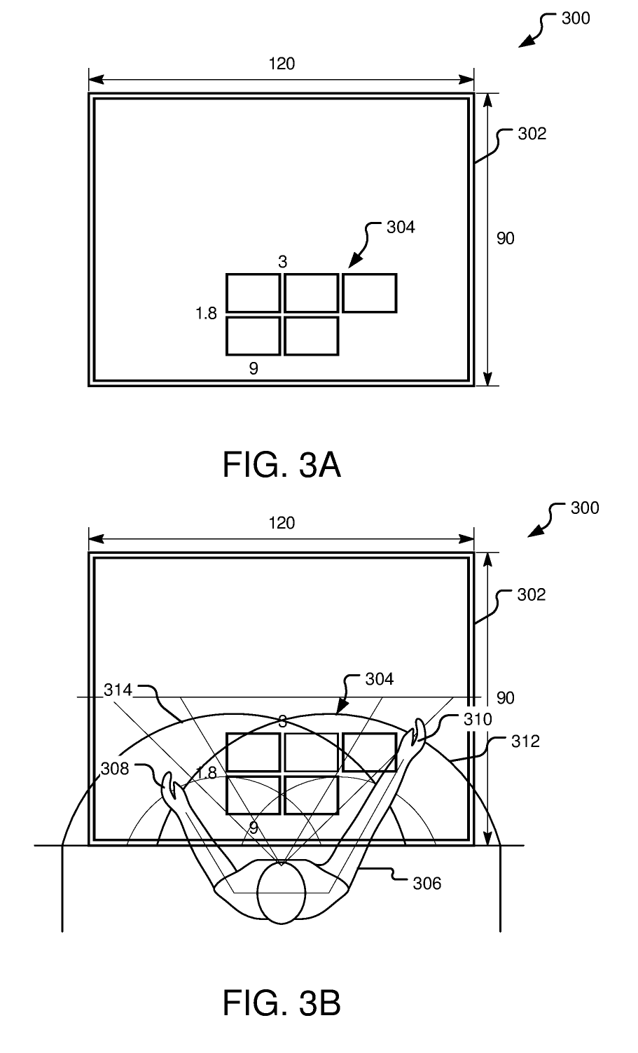

FIG. 3A illustrates an example arrangement 300 of virtual objects 304 projected onto a surface 302 by a virtual content surface re-mapper (such as the virtual content surface re-mapper 122 of FIG. 1) of a device operating in a three-dimensional use mode. In one implementation, the surface 302 is a physical real-world surface that a user 306 (as shown in FIG. 3B) is able to observe through projection optics of a device generating the virtual objects 304 while operating in an AR mode.

FIG. 3B illustrates a user positioned relative to the example arrangement of virtual objects shown in 3A. In FIG. 3B, the user 306 has selected the virtual objects 304 from a virtual interface and provided a surface selection instruction to select the surface 302 for a re-projection operation. The virtual content surface re-mapper determines various attributes of the surface 302, such as size, orientation, and location relative to the user 306. If the surface 302 is a physical surface, the virtual content surface re-mapper may receive and analyze data collected by one or more environmental sensors (e.g., cameras, depth sensors) of the device. If the surface 302 is a virtual surface, the virtual content surface re-mapper may communicate with the application that generated the surface 302 to determine attributes of the surface 302. In addition to determining attributes of the surface 302, the virtual content surface re-mapper may also determine attributes of the user 306, such as the user's height, current location relative to the selected surface, and arm reach.

In the illustrated example, the surface 302 has a horizontal orientation (like a table) relative to the user 306. The virtual content surface re-mapper determines the aspect ratio of the table and the aspect ratio of each of the individual virtual objects 304. Additionally, the virtual content surface re-mapper determines a position of the user 306 relative to the surface 302 and a length of the user's arms. Based on this information, the virtual content surface re-mapper further determines an interaction area including a first zone 312 in reach of the user's right hand 310 and a second zone 314 in reach of the user's left hand 308. The virtual content surface re-mapper further determines a dominant hand (e.g., the right hand), such as based on profile information or detected movements of the user.

Based on this collected information, the virtual content surface re-mapper selects a size for each the virtual content items, such as the size that realistically resembles a paper document relative to the surface 302 and/or the user's position and hand size. In one implementation, the virtual content surface re-mapper sizes the selected virtual objects to be larger when the user 306 is further away from the surface 302 and smaller when the user 306 is closer to the surface 302.

After selecting the appropriate size for the virtual objects 304, the virtual content surface re-mapper determines an arrangement and positioning of the virtual objects 304 relative to the user 306 and the surface 302. In the illustrated example, the selected arrangement maximizes a number of the virtual objects 304 that are within an overlap region of the interaction area 316 between the first zone 312 and the second zone 314 and therefore in reach of both of the user's hands (308 and 310). Virtual objects that do not fit within this overlap zone are placed within reach of the user's dominant hand (e.g., the right hand 310).

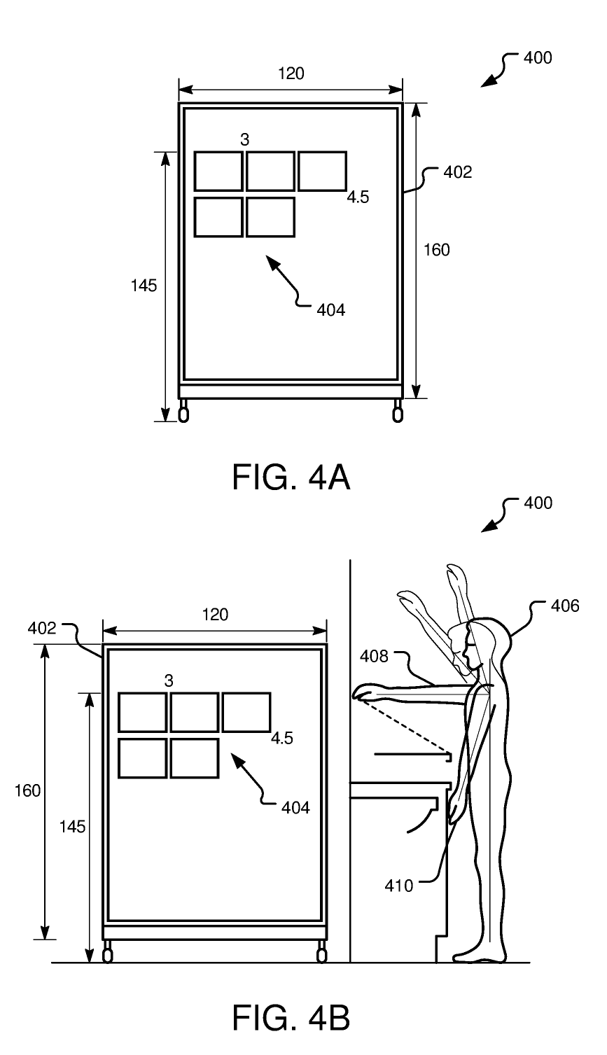

FIG. 4A illustrates another example arrangement 400 of virtual objects 404 projected onto a surface 402 by a virtual content surface re-mapper (such as the virtual content surface re-mapper 122 of FIG. 1) of a device operating in a three-dimensional use mode.

FIG. 4B illustrates a user positioned relative to the example arrangement of virtual objects shown in FIG. 4A. In FIG. 4B, a user 406 has selected the virtual objects 404 from a virtual interface and provided a surface selection instruction to select the surface 402. The virtual content surface re-mapper determines various attributes of the surface 402, such as size, orientation, and location relative to the user 406.

The virtual surface content re-mapper determines attributes of the surface 402 and/or the user 406 in a manner that may be the same or similar to that described above with respect to FIG. 2D and FIG. 3. In the example of FIG. 4B, the surface 402 has a vertical orientation relative to the user 406 (e.g., a wall or whiteboard). The virtual content surface re-mapper determines the aspect ratio of the table and the aspect ratio of each of the individual virtual objects 404. Additionally, the virtual content surface re-mapper determines a position of the user 406 relative to the surface 402 and a length of the user's arms. Based on this information, the virtual content surface re-mapper further determines upper and lower bounds on the surface 402 within reach of one or both hands (408, 410) of the user 406 and identifies the user's right hand 410 as being a dominant hand, such as based on profile information or detected movements of the user.

Based on some or all of this collected information, the virtual content surface re-mapper selects a size for each of the virtual content items and determines an arrangement and positioning of the virtual objects 404 relative to the user 406 and the surface 402. In the illustrated example, the selected arrangement places the virtual objects 404 within reach of a user's arms from the user's current position.

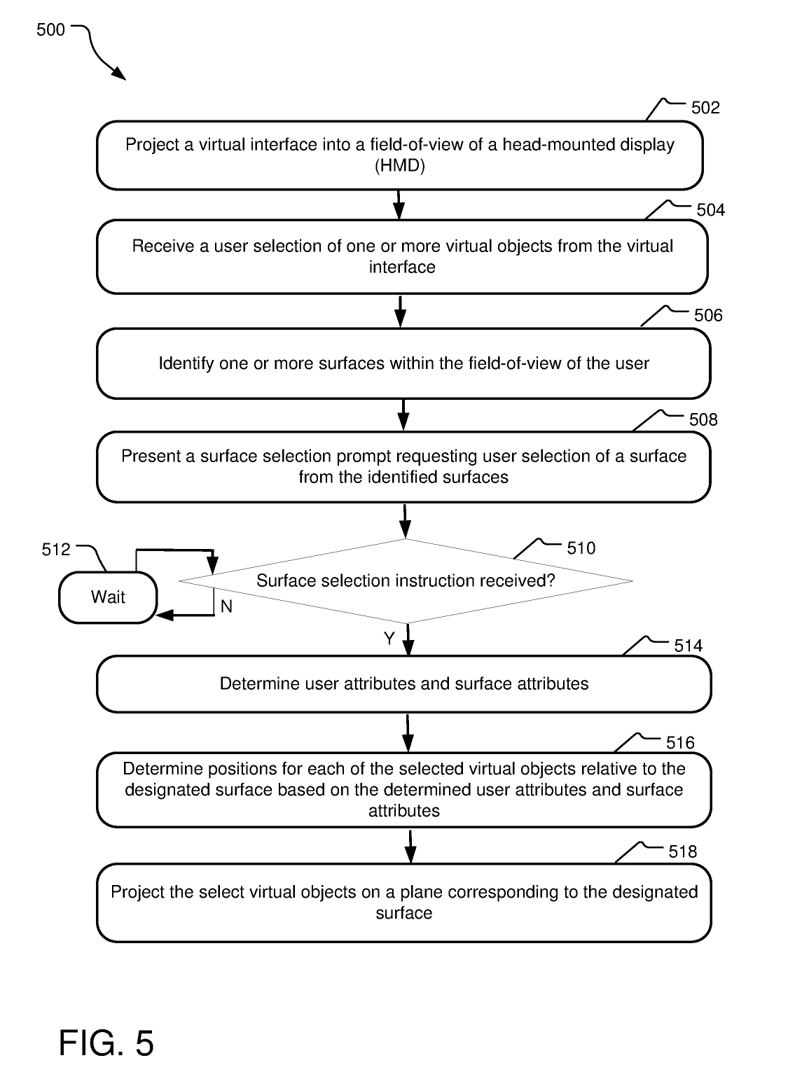

FIG. 5 illustrates example operations 500 for re-mapping virtual objects between different virtual and/or or real-world surfaces. A projection operation 502 uses projection optics of a head-mounted-device (HMD) to project a three-dimensional virtual interface into a field-of-view of a user wearing the HMD.

A receiving operation 504 receives a user selection of one or more select virtual objects from the virtual interface. An identifying operation 506 identifies one or more surfaces within the field-of-view of the user. For example, the identified surfaces may include a virtual surface generated by an application external to the application that generated the virtual interface and selected virtual objects. In the same or other implementation, the HMD device operates in an AR mode and the identified surfaces include one or more physical surfaces, such as walls and/or tables present in the user's real-world surroundings.

A presentation operation 508 presents a surface selection prompt requesting user selection of a surface from the identified surfaces within the field-of-view of the user. A determination operation 510 determines whether the surface selection instruction has been received. If the surface selection has not yet been received, a waiting operation 512 commences until the user provides such instruction designating a select one of the identified surfaces.

Once determination operation 510 determines that the surface selection has been received from the user, an attribute determination operation 514 determines attributes of a surface designated by the surface selection instruction and attributes of the user, such as attributes pertaining to size, location, surface orientation, and user reach including without limitation the specific example surface attributes and user attributes described above with respect to FIGS. 1, 3, and 4.

A position determination step 516 selectively determines positions for each of the virtual objects relative to the designated surface based on the user attributes and surface attributes determined by the attribute determination operation 514. A projection operation 518 projects the select virtual objects on a plane corresponding to the designated surface according to the determined arrangement.

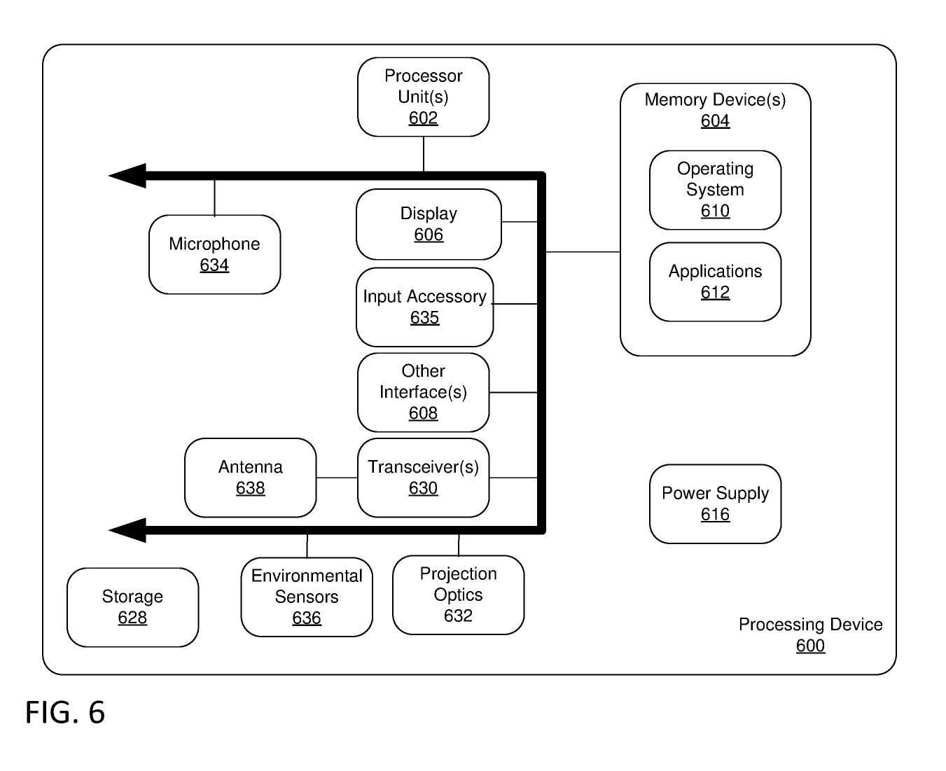

FIG. 6 illustrates an example schematic of a processing device 600 suitable for implementing aspects of the disclosed technology. The processing device 600 includes one or more processor unit(s) 602, memory 604, a display 606, and other interfaces 608 (e.g., buttons). The memory 604 generally includes both volatile memory (e.g., RAM) and non-volatile memory (e.g., flash memory). An operating system 610, such as the Microsoft Windows® operating system, the Microsoft Windows® Phone operating system or a specific operating system designed for a gaming device, resides in the memory 604 and is executed by the processor unit(s) 602, although it should be understood that other operating systems may be employed.

One or more applications 612, such as the virtual content surface re-mapper (such as the virtual content surface re-mapper 122 of FIG. 1), are loaded in the memory 604 and executed on the operating system 610 by the processor unit(s) 602. Applications 612 may receive input from various input devices such as a microphone 634, input accessory 635 (e.g., keypad, mouse, stylus, touchpad, gamepad, racing wheel, joystick), or various environmental sensors 636 such as one or more cameras or depth sensors. The processing device 600 includes projection optics 632 for projecting virtual objects of the applications 612 when operating in a VR or AR device mode. The processing device 600 further includes a power supply 616, which is powered by one or more batteries or other power sources and which provides power to other components of the processing device 600. The power supply 616 may also be connected to an external power source (not shown) that overrides or recharges the built-in batteries or other power sources.

The processing device 600 includes one or more communication transceivers 630 and an antenna 638 to provide network connectivity (e.g., a mobile phone network, Wi-Fi®, Bluetooth®). The processing device 600 may also include various other components, such as a positioning system (e.g., a global positioning satellite transceiver), one or more accelerometers, one or more cameras, an audio interface (e.g., the microphone 634, an audio amplifier and speaker and/or audio jack), and storage devices 628. Other configurations may also be employed.

In an example implementation, a mobile operating system, various applications (e.g., an optical power controller or vergence tracker) and other modules and services may have hardware and/or software embodied by instructions stored in the memory 604 and/or the storage devices 628 and processed by the processor unit(s) 602. The memory 604 may be the memory of a host device or of an accessory that couples to the host.

The processing device 600 may include a variety of tangible computer-readable storage media and intangible computer-readable communication signals. Tangible computer-readable storage can be embodied by any available media that can be accessed by the processing device 600 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 600. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some implementations may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

An example system disclosed herein includes a virtual content surface re-mapper stored in memory and executable by a processor to receive user input selecting one or more virtual objects presented on a virtual interface of an application executing in a three-dimensional use mode; identify one or more surfaces within a field-of-view of a user and external to the application; present a surface selection prompt requesting user selection of a surfaces from the identified surfaces; receive a surface selection instruction responsive to the presentation of the surface selection prompt, the surface selection instruction specifying a designated surfaces from the identified surfaces; and project the one or more selected virtual objects onto a plane corresponding to the designated surface.

In another example system of any preceding system, the one or more identified surfaces include at least one physical surface and the virtual content surface re-mapper is further executable to: control a camera to collect imagery of a user environment; and identify the one or more surfaces from the collected imagery.

In another example system of any preceding system, the one or more identified surfaces include one or more virtual surfaces.

In still another example system of any preceding system, the selected virtual objects include at least one virtual object representing a collection of other virtual objects and the virtual content surface re-mapper projects the one or more selected virtual objects onto the plane by projecting the collection of other virtual objects onto the plane corresponding to the selected surface.

In still another example system of any preceding system, the system further comprises a content arranger and projection mapping tool stored in the memory and executable to arrange the selected virtual objects for projection onto the designated surface based on a detected separation between the user and the designated surface.

In another example system of any preceding system, the system further includes the content arranger and projection mapping tool stored in the memory and executable to arrange the selected virtual objects for projection onto the designated surface based on a detected dimension of the user.

Another example system of any preceding system further includes the content arranger and projection mapping tool stored in the memory and executable to arrange the selected virtual objects for a projection onto the designated surface based on a determined hand preference of the user.

Still another example system of any preceding system further includes the content arranger and projection mapping tool in the memory and executable to arrange the selected virtual objects for projection onto the designated surface based on an identified interaction area of the designated surface that is within physical reach of the user.

An example method disclosed herein includes receiving a selection of one or more virtual objects projected into a field-of-view of a user by a processing device executing an application in a three-dimensional use mode and identifying one or more surfaces within the field-of-view and external to the application that generated the selected virtual objects. The method further provides for presenting a surface selection prompt requesting user selection of a surface from the identified surfaces; receiving a surface selection instruction responsive to the presentation of the surface selection prompt, the surface selection instruction specifying a designated surface from the identified surfaces; and projecting the one or more selected virtual objects onto a plane corresponding to the designated surface.

In still another example method of any preceding method, identifying the one or more surfaces within the field-of-view of the user further comprises identifying at least one physical surface within a real-world environment visible through projection optics generating the virtual objects. The method further comprises collecting imagery of a user environment; and identifying the one or more surfaces from the collected imagery.

In yet still another example method of any preceding method, the one or more identified surfaces include one or more virtual surfaces.

In yet still another example method of any preceding method, the selected virtual objects include at least one virtual object representing a collection of other virtual objects and projecting the one or more selected virtual objects further comprises projecting the collection of other virtual objects onto the plane corresponding to the selected surface.

In still another example method of any preceding method, the method further comprises arranging the selected virtual objects for projection onto the designated surface based on a detected separation between the user and the designated surface.

In yet still another example method of any preceding method, the method further comprises arranging the selected virtual objects for projection onto the designated surface based on based on a detected dimension of the user.

In still another example method of any preceding method, the method further comprises arranging the selected virtual objects for projection onto the designated surface based on a determined hand preference of the user.

Another example method of any preceding method further comprises arranging the select virtual objects for a projection onto the designated surface based on an identified interaction area of the designated surface that is within physical reach of the user

An example computer-readable storage media encodes a computer process comprising” receiving a selection of one or more virtual objects projected into a field-of-view of a user by a processing device executing an application in a three-dimensional use mode; identifying one or more surfaces within the field-of-view of the user and external to an application that created the selected virtual objects; presenting a surface selection prompt requesting user selection of a surface from the identified surfaces; receiving a surface selection instruction responsive to the presentation of the surface selection prompt, the surface selection instruction specifying a designated surface from the identified surfaces; and projecting the one or more selected virtual objects onto a plane corresponding to the designated surface.

An example computer process of any preceding computer process further comprises arranging the selected virtual objects for projection onto the designated surface based on a detected separation between a user and the designated surface.

Still another example computer process of any preceding computer process further comprises arranging the selected virtual objects for projection onto the designated surface based on a detected dimension of a user.

Yet still another example computer process of any preceding computer process comprises arranging the selected virtual objects for projection onto the designated surface based on a predefined hand preference of a user.

An example system disclosed herein includes a means for receiving user input selecting one or more virtual objects presented on a virtual interface of an application executing in a three-dimensional use mode; a means for identifying one or more surfaces within a field-of-view of a user and external to the application; a means for presenting a surface selection prompt requesting user selection of a surface from the identified surfaces; a means for receiving a surface selection instruction responsive to the presentation of the surface selection prompt, the surface selection instruction specifying a designated surface from the identified surfaces; and a means for projecting the one or more selected virtual objects onto a plane corresponding to the designated surface.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. A system comprising:
a processor; and
a virtual content surface re-mapper stored in memory and executable by the processor to:
receive user input selecting one or more virtual objects presented on a virtual interface of an application executing in a three-dimensional use mode;
identify one or more surfaces within a field-of-view of a user and external to the application;
present a surface selection prompt requesting user selection of a surface from the identified surfaces;
receive a surface selection instruction responsive to the presentation of the surface selection prompt, the surface selection instruction specifying a designated surface from the identified surfaces; and
project the one or more selected virtual objects onto a plane corresponding to the designated surface.

2. The system of claim 1, wherein the one or more identified surfaces include at least one physical surface and the virtual content surface re-mapper is further executable to:
control a camera to collect imagery of a user environment; and
identify the one or more surfaces from the collected imagery.

3. The system of claim 1, wherein the one or more identified surfaces include one or more virtual surfaces.

4. The system of claim 1, wherein the selected virtual objects include at least one virtual object representing a collection of other virtual objects and wherein the virtual content surface re-mapper projects the one or more selected virtual objects onto the plane by projecting the collection of other virtual objects onto the plane corresponding to the selected surface.

5. The system of claim 1, further comprising:
a content arranger and projection mapping tool stored in the memory and executable to arrange the selected virtual objects for projection onto the designated surface based on a detected separation between the user and the designated surface.

6. The system of claim 1, further comprising:
a content arranger and projection mapping tool stored in the memory and executable to arrange the selected virtual objects for a projection onto the designated surface based on a detected dimension of the user.

7. The system of claim 1, further comprising:
a content arranger and projection mapping tool stored in the memory and executable to arrange the selected virtual objects for projection onto the designated surface based on a determined hand preference of the user.

8. The system of claim 1, further comprising:
a content arranger and projection mapping tool stored in the memory and executable to arrange the selected virtual objects for projection onto the designated surface based on an identified interaction area of the designated surface that is within physical reach of the user.

9. A method comprising:
receiving, at a processor, a selection of one or more virtual objects projected into a field-of-view of a user by a processing device executing an application in a three-dimensional use mode;
identifying one or more surfaces within the field-of-view and external to the application that generated the selected virtual objects;
presenting a surface selection prompt requesting user selection of a surface from the identified surfaces;
receiving a surface selection instruction responsive to the presentation of the surface selection prompt, the surface selection instruction specifying a designated surface from the identified surfaces; and
projecting the one or more selected virtual objects onto a plane corresponding to the designated surface.

10. The method of claim 9, wherein identifying the one or more surfaces within the field-of-view of the user further comprises identifying at least one physical surface within a real-world environment visible through projection optics generating the virtual objects and the method further comprises:
collecting imagery of a user environment; and
identifying the one or more surfaces from the collected imagery.

11. The method of claim 9, wherein the one or more identified surfaces include one or more virtual surfaces.

12. The method of claim 9, wherein the selected virtual objects include at least one virtual object representing a collection of other virtual objects and wherein projecting the one or more selected virtual objects further comprises:
projecting the collection of other virtual objects onto the plane corresponding to the selected surface.

13. The method of claim 9 further comprising:
arranging the selected virtual objects for projection onto the designated surface based on a detected separation between the user and the designated surface.

14. The method of claim 9, further comprising:
arranging the selected virtual objects for projection onto the designated surface based on based on a detected dimension of the user.

15. The method of claim 9, further comprising:
arranging the selected virtual objects for projection onto the designated surface based on a determined hand preference of the user.

16. The method of claim 9, further comprising:
arranging the select virtual objects for projection onto the designated surface based on an identified interaction area of the designated surface that is within physical reach of the user.

17. One or more computer-readable storage media encoding computer-executable instructions for executing on a computer system a computer process, the computer process comprising:
receiving, at a processor, a selection of one or more virtual objects projected into a field-of-view of a user by a processing device executing an application in a three-dimensional use mode;
identifying one or more surfaces within the field-of-view of the user and external to the application that created the selected virtual objects;
presenting a surface selection prompt requesting user selection of a surface from the identified surfaces;
receiving a surface selection instruction responsive to the presentation of the surface selection prompt, the surface selection instruction specifying a designated surface from the identified surfaces; and
projecting the one or more selected virtual objects onto a plane corresponding to the designated surface.

18. The one or more computer-readable storage media of claim 17, wherein the computer process further comprises:
arranging the selected virtual objects for projection onto the designated surface based on a detected separation between the user and the designated surface.

19. The one or more computer-readable storage media of claim 17, wherein the computer process further comprises:
arranging the selected virtual objects for projection onto the designated surface based on a detected dimension of the user.

20. The one or more computer-readable storage media of claim 17, wherein the computer process further comprises:
arranging the selected virtual objects for projection onto the designated surface based on a predefined hand preference of the user.
